(19) United States
(12) Patent Application Publication
(10) Pub. No.: US 2026/0241401 A1
(43) Pub. Date: Aug. 20, 2026

(54) IMPROVED TABLE TOP DISPENSER

(71) Applicant: GOJO Industries, Inc., Akron, OH (US)

(72) Inventors: Nick E. Ciavarella, Seven Hills, OH (US); Aaron D. Marshall, Louisville, OH (US)

(21) Appl. No.: 19/165,416

(22) PCT Filed: Mar. 15, 2024
(86) PCT No.: PCT/US2024/020094

§ 371 Date: Sep. 15, 2025

Related U.S. Application Data
(60) Provisional application No. 63/490,839, filed on Mar. 17, 2023.

(51) Int. Cl. B05B 11/10

(52) U.S. Cl. CPC B05B 11/1087

(57) ABSTRACT

An exemplary upright foam dispenser includes a reservoir, a foam pump located above the reservoir. The foam pump includes a foam generator, a liquid pump chamber, a liquid pump chamber inlet. A dip tube extends from the liquid pump chamber inlet to proximate the bottom of the reservoir. The foam pump includes a passageway that extends from the liquid pump chamber outlet to the foam generator. The pump further includes an air pump chamber and an opening located in the air pump chamber placing the air pump chamber in fluid communication with the central passageway. The area above the opening defines an upper air pump chamber portion of the air pump chamber and wherein the area below the opening is a lower air pump chamber portion. The volume of the upper pump chamber is less than about 15 percent of the volume of the lower pump chamber. The dispenser includes an outlet nozzle located above the pump. The pump is configured to draw air and residual liquid through the foam generator and outlet nozzle into the air pump chamber. The residual liquid settles at the bottom of the air pump chamber. The air pump chamber is configured so that residual liquid builds up and at least a portion remains in the bottom of the air pump chamber.

### BACKGROUND OF THE INVENTION

FIG. 1 is a prior art pump 130 for use with a dispenser system that has a non-collapsing container 102 located above pump 130. A detailed description of the prior art pump may be found in U.S. Pat. No. 9,936,840 (the '840 patent). The pump 130 is designed to be operated in the inverted orientation shown in the '840 patent with the pump located below the container 102. The pump 130 includes a liquid pump chamber 160, a liquid inlet valve 162, a liquid outlet valve 166, and an opening 168 through the piston 164 into a central passageway 170. In addition, pump 130 includes an air pump chamber 111, an air piston 132, that includes a wiper seal vale 112, an aperture 180 between the air pump chamber 111 into the central passageway 170, a foaming chamber 190 and a foam outlet 192.

Pump 130 includes a container vent valve 118 located in an annular projection 120. An air flow path 115 allows ambient air to reach vent valve 118 to vent the container 102.

Pump 130 is designed to be used in an inverted position as shown and dispense foam from the outlet 192 located at the bottom of the dispensing system. In the inverted position, when liquid pump chamber 160 is compressed, liquid flows through central passage 170. Simultaneously, air pump chamber 111 compresses and air flows through aperture 180 into central passage 170. The air/liquid mixture is forced through outlet nozzle 192 and dispensed onto a user's hand. Residual liquid in passage 170, foaming chamber 190 and foam outlet 192 may be drawn into a lower bason 190 area in air pump chamber 111 during the return stroke as the air pump chamber reprimes. Because the aperture 180 is located near the bottom of bason 190 in the air pump chamber 111, any liquid that settles in bason 190 is blown through aperture 180 during a subsequent dispenser. Indeed, the pump is designed with aperture 180 as close to the bottom of bason 190 as possible, while preventing residual liquid and foam sucked back into the air chamber 111 from spilling out of aperture 180 and dipping out of the outlet nozzle 192 after use. The most liquid that can collect in bason 190 would be liquid to the height of aperture 180. If liquid in bason 190 is above, the aperture 180, that liquid will flow out of the pump and cause dripping. Also, the diameter of the lower bason 190 is small and sized to hold only the maximum amount of liquid that would result from the “suck-back” of residual foam and liquid in the mixing chamber 191, outlet nozzle 192 and central passage 170. In addition, as can be seen from the figures, liquid in bason 190 that is below the height of aperture 180 does not reduce the volume of the air pump chamber 111 significantly.

### SUMMARY OF THE INVENTION

An exemplary upright foam dispenser includes a reservoir, a foam pump located above the reservoir. The foam pump includes a foam generator, a liquid pump chamber, and a liquid pump chamber inlet. A dip tube extends from the liquid pump chamber inlet to the bottom of the reservoir. The foam pump includes a passageway that extends from the liquid pump chamber outlet to the foam generator. The pump further includes an air pump chamber and an opening located in the air pump chamber placing the air pump chamber in fluid communication with the central passageway. The area above the opening defines an upper air pump chamber portion of the air pump chamber and the area below the opening defines a lower air pump chamber portion. The volume of the upper air pump chamber is less than about 15 percent of the volume of the lower air pump chamber. The dispenser includes an outlet nozzle located above the pump. The pump is configured to draw air and residual liquid through the foam generator and outlet nozzle into the air pump chamber. The residual liquid settles at the bottom of the air pump chamber. The air pump chamber is configured so that residual liquid builds up and at least a portion remains in the bottom of the air pump chamber.

Another exemplary upright foam dispenser includes a reservoir, a foam pump located above the reservoir. The foam pump includes a foam generator, a liquid pump chamber, a liquid pump chamber inlet. A dip tube extends from the liquid pump chamber inlet to the bottom of the reservoir. The foam pump includes a passageway that extends from the liquid pump chamber outlet to the foam generator. The pump further includes an air pump chamber and an opening located in the air pump chamber that places the air pump chamber in fluid communication with the central passageway. The area above the opening defines an upper air pump chamber portion of the air pump chamber and the area below the opening defines a lower air pump chamber portion. The lower air pump chamber portion has a maximum diameter that is greater than a maximum diameter of the upper air pump chamber portion. The dispenser includes an outlet nozzle located above the pump. The pump is configured to draw air and residual liquid through the foam generator and outlet nozzle into the air pump chamber. The residual liquid settles at the bottom of the air pump chamber. The air pump chamber is configured so that residual liquid builds up and at least a portion remains in the bottom of the air pump chamber.

Another exemplary upright foam dispenser includes a reservoir, a foam pump located above the reservoir. The foam pump includes a foam generator, a liquid pump chamber, a liquid pump chamber inlet. A dip tube extends from the liquid pump chamber inlet to proximate the bottom of the reservoir. The foam pump includes a passageway that extends from the liquid pump chamber outlet to the foam generator. The pump further includes an air pump chamber and an opening located in the air pump chamber placing the air pump chamber in fluid communication with the central passageway. The area above the opening defines an upper air pump chamber portion of the air pump chamber and the area below the opening defines a lower air pump chamber portion. The lower air pump chamber portion has a lower air pump chamber portion height. The upper air pump chamber portion has an upper air pump chamber portion height. The lower air pump chamber portion height is greater than the upper air pump chamber portion height. The pump is configured to draw air and residual liquid through the foam generator and outlet nozzle into the air pump chamber and the residual liquid settles in a bottom of the lower air pump chamber portion. The air pump chamber is configured so that residual liquid builds up and remains in the bottom of the lower air pump chamber portion.

Another exemplary upright foam dispenser includes a reservoir and a foam pump located above the reservoir. The foam pump includes a foam generator, a liquid pump chamber, and a liquid pump chamber inlet. A dip tube extends from the liquid pump chamber inlet to proximate the bottom of the reservoir. The pump includes a passageway extending from the liquid pump chamber outlet to the foam generator and an air pump chamber. The air pump chamber has an upper end and a lower end. An opening is located in the air pump chamber placing the air pump chamber in fluid communication with the central passageway. The opening is located proximate the upper end of the air pump chamber. The dispenser includes an outlet nozzle located above the pump. The pump is configured to draw air and residual liquid through the foam generator and outlet nozzle into the air pump chamber and the residual liquid settles at the bottom of the air pump chamber. The air pump chamber is configured so that residual liquid builds up and at least a portion remains in the bottom of the air pump chamber.

An exemplary method for dispensing foam includes providing a dispenser having a reservoir and a foam pump located above the reservoir. The foam pump includes a foam generator, a liquid pump chamber, a liquid pump chamber inlet, and a liquid pump chamber outlet. The liquid pump chamber outlet is located below the liquid pump chamber inlet. A passageway extends from the liquid pump chamber outlet to the foam generator. The foam pump includes an air pump chamber and an opening located in the air pump chamber placing the air pump chamber in fluid communication with the passageway. The opening is located proximate the top of the air pump chamber. The area above the opening is an upper air pump chamber portion of the air pump chamber and the area below the opening is a lower air pump chamber portion. The method further includes causing the dispenser to be actuated. Actuating the dispenser compresses the liquid pump chamber and air pump chamber to dispense foam. During operation of the dispenser, residual foam that includes residual liquid and air is drawn into the air pump chamber as the air pump chamber expands. The residual liquid settles at the bottom of the air pump chamber. The air pump chamber is configured so that the residual liquid builds up during operation of the foam pump and residual liquid remains in the bottom of the air pump chamber after a selected number of operations of the dispenser to dispense foam.

### BRIEF DESCRIPTION OF DRAWINGS

FIG. 1 is a prior art pump for use in an inverted position;

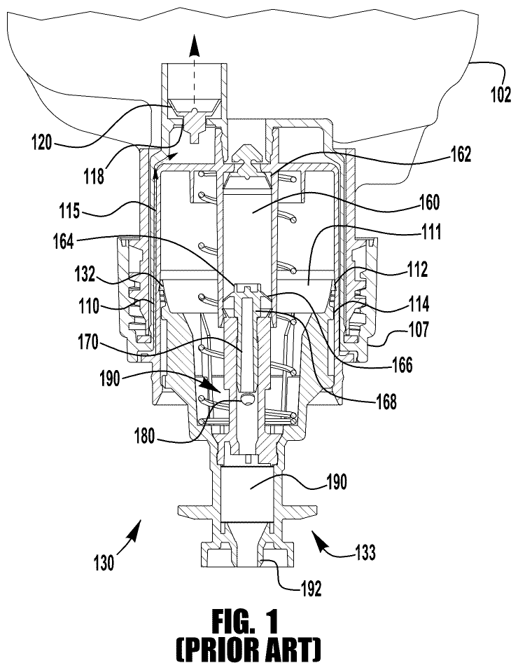

FIG. 2 is an exemplary embodiment of a table-top dispenser;

FIG. 3 is a cross-sectional view of the exemplary table-top dispenser of FIG. 2; and

FIG. 4 is a cross section of an exemplary embodiment of an upright pump for the table-top dispenser of FIG. 2.

### DETAILED DESCRIPTION OF THE INVENTION

The following description refers to the accompanying drawings, which illustrate specific aspects of the present disclosure.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

Values identified in the detailed description may be exemplary and may be different as needed for a particular dispenser and/or refill design. Accordingly, the inventive concepts disclosed and claimed herein are not limited to the particular values or ranges of values used to describe the embodiments disclosed herein.

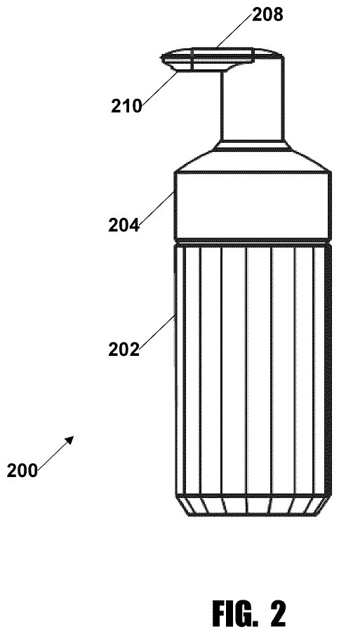

FIG. 2 is a table-top foam sanitizer dispenser 200. Table-top foam sanitizer dispenser 200 includes a lower housing 202, a pump housing 204, a pump head 208 and an outlet nozzle 210.

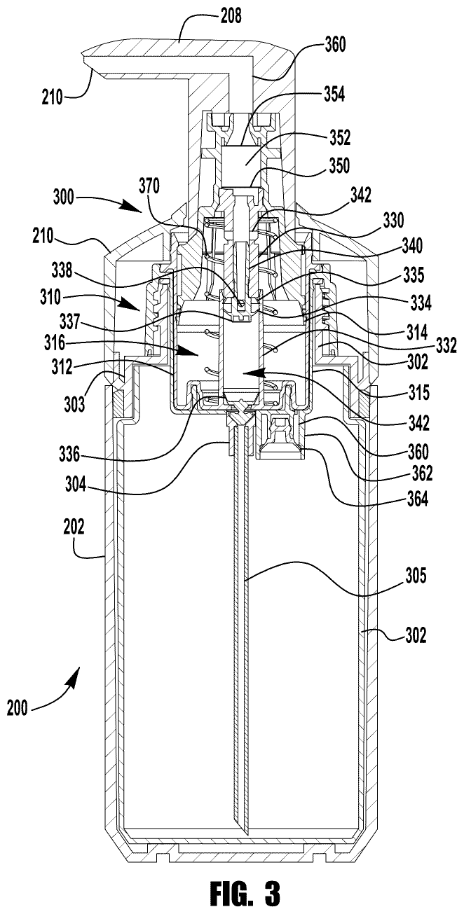

FIG. 3 is a cross-section of the table-top foam sanitizer dispenser 200. Table-top foam sanitizer dispenser 200 includes a container 302 located within lower housing 202.

Upper housing 210 includes a pump support 303 that supports pump 300. Pump 300 includes a liquid pump chamber 342, a liquid inlet 304. Connected to liquid inlet is a dip tube 305. Dip tube 305 extends from liquid inlet 304 to proximate the bottom of container 302. Pump 300 includes a liquid inlet valve 336, which is a wiper seal valve, and defines at least a portion of the liquid pump chamber 342. A liquid outlet valve 334 defines at least a portion of the liquid pump chamber. Liquid outlet valve 334 is located at the end of piston 330. Piston 330 moves to expand and compress liquid pump chamber 342. An aperture 338 allows liquid to flow into a central passageway 340 in piston 330. A second wiper seal 335 prevents liquid from flowing on the outside of piston 330. Central passageway 340 extends to foaming chamber 352. Foaming chamber 352 may include optional mix media, such as, for example, one or more optional screens 350, 352. A sponge (not shown) may also be included, either with or without the optional screens. Passageway 360 places foaming chamber 352 in fluid communication with dispensing outlet 210.

Pump 300 includes an air pump chamber 316. Piston 330 includes a wiper valve 314 that seals against pump housing 315 and moves up and down with piston 330 to compress and expand air pump chamber 316. Located close to the top of the air pump chamber 316 is one or more apertures 342 placing the air pump chamber in fluid communication with the central passageway 340.

During operation, when pump head 208 is pushed down, piston 330 moves downward compressing the liquid pump chamber 342 and the air pump chamber 316. Liquid from liquid pump chamber 342 flows past liquid outlet valve 334, through aperture 338 and into central passageway 340. Simultaneously air pump chamber 316 compresses forcing air to flow through aperture 342 into central passageway 340. The liquid and air mix together and are force through foaming chamber 352, outlet passage 360 and out of dispensing nozzle 210 in the form of a foam.

After pump head 208 is released, a spring 370 causes the piston 330 to move upward expanding the liquid pump chamber 342 and air pump chamber 316. Liquid flows up the dip tube 305, past liquid inlet valve 336 and into liquid pump chamber 342.

Simultaneously, air pump chamber 216 expands. As air pump chamber 216 expands, air, residual liquid and residual foam is drawn back through dispensing nozzle, outlet passage 360, foaming chamber 352 and central passage 340 into the air pump chamber 316 where the liquid settles at the bottom of the air pump chamber 316. During subsequent dispenses, at least a portion of the liquid that is at the bottom of air pump chamber 316 remains in the air pump chamber 316.

Surprisingly, pump 300 continues to operate as liquid pools in the bottom of air pump chamber 316, which reduces the volume of the air pump chamber. Even more surprising, after a sufficient level of liquid pools in the bottom of the air pump chamber 316 the foam output has smaller bubbles and therefore appears to be a higher quality foam. The term higher quality foam means that the foam is thicker and richer in appearance then the foam that was produced prior to a sufficient level of liquid pooling in the base of the air pump chamber 316. Also surprising is that some of the liquid that pools in the bottom of the air pump chamber 316 is re-foamed by subsequent air pump activations and that foam flows out of the air pump chamber through the aperture 342 that is located at the top of the air pump chamber 316. Also surprising is that the pump 300 continues to function as liquid builds up in the air pump chamber 316.

In addition, the liquid in the air pump chamber 316 takes up space in the air pump chamber 316. It has been discovered that there is space in the air pump chamber that is normally “uncompressed” space. In other words, when the air pump chamber 316 is fully compressed, there remains an area in air pump chamber 316 that contains air. The liquid in the air pump chamber 316 fills the uncompressed space. Filling the uncompressed space with liquid improves the performance of the air pump chamber 316 and the air pump chamber 316 is able to generate increased pressure.

A chamber venting insert 362 is also included. A one-way air inlet valve 364 is located in the venting insert. Ambient air may enter chamber 360 from around the pump housing. One-way air inlet valve 364 seals against cylindrical wall 362 and when enough vacuum pressure develops in container 302, one-way air inlet valve 364 cracks and allows air to flow into container 302.

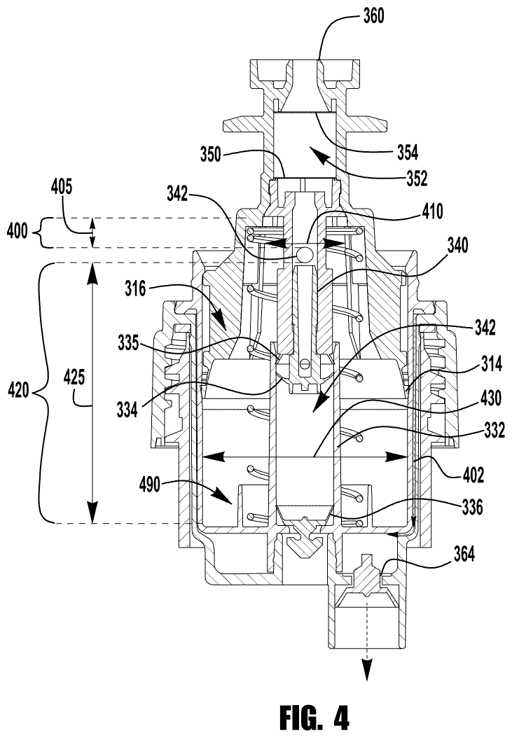

FIG. 4 is an enlarged view of pump 300. The area of air pump chamber 316 located above aperture 342 is the upper air pump chamber portion 400. The upper air pump chamber portion 400 has a height 405. In addition, the upper air pump chamber portion 400 as a volume. In addition, the upper air pump chamber portion 400 has a maximum diameter 410. The area of air pump chamber 316 that is below aperture 342 is the lower air pump chamber portion 420. The lower air pump chamber portion 420 has a height 425. In addition, the lower air pump chamber portion 420 as a volume. In addition, the lower air pump chamber portion has a maximum diameter 430.

The volume of upper air pump chamber portion 400 is less than the volume of lower air pump chamber portion 420. In some embodiments, the volume of upper air pump chamber portion 400 is 15% of the volume of the lower air pump portion 420. In some embodiments, the volume of upper air pump chamber portion 400 is 10% of the volume of the lower air pump portion 420. In some embodiments, the volume of upper air pump chamber portion 400 is 8 % of the volume of the lower air pump portion 420. In some embodiments, the volume of upper air pump chamber portion 400 is 5 % of the volume of the lower air pump portion 420.

The height 425 of lower air pump chamber portion 420 is greater than the height 405 of upper air pump chamber portion 400. In some embodiments, the height 425 of lower air pump chamber portion 420 is 10 times the height 405 of lower air pump chamber portion 400. In some embodiments, the height 425 of lower air pump chamber portion 420 is 8 times the height 405 of lower air pump chamber portion 400. In some embodiments, the height 425 of lower air pump chamber portion 420 is 6 times the height 405 of lower air pump chamber portion 400. In some embodiments, the height 425 of lower air pump chamber portion 420 is 5 times the height 405 of lower air pump chamber portion 400. In some embodiments, the height 425 of lower air pump chamber portion 420 is 4 times the height 405 of lower air pump chamber portion 400.

The maximum diameter 430 of lower pump chamber 420 is greater than the maximum diameter 410 of upper pump chamber 400. In some embodiments, the maximum diameter 430 of lower pump chamber portion 420 is 2 times the maximum diameter 410 of the upper pump chamber 400. In some embodiments, the maximum diameter 430 of lower pump chamber portion 420 is 1.75 times the maximum diameter 410 of the upper pump chamber 400. In some embodiments, the maximum diameter 430 of lower pump chamber portion 420 is 1.5 times the maximum diameter 410 of the upper pump chamber 400. In some embodiments, the maximum diameter 430 of lower pump chamber portion 420 is 1.25 times the maximum diameter 410 of the upper pump chamber 400.

During operation of pump 300 residual liquid pools in the bottom of air pump chamber 316. The volume of the residual liquid builds up as pump 300 is operated. Some of the residual liquid may flow out of the air pump chamber 316, however at least a portion of the residual liquid remains in the air pump chamber 316. The liquid that remains in the air pump chamber 316 fills the uncompressed space in the air pump chamber 316.

In some embodiments, after the pump 316 has been operated a selected number of times, such as, for example, 10 times, the volume of residual liquid that remains after the next dispense is at least 0.3 milliliters (ml) of liquid. In some embodiments, the volume of residual liquid that remains after the next dispense is 0.4 mls of liquid. In some embodiments, the volume of residual liquid that remains after the next dispense is 0.5 mls of liquid. In some embodiments, the volume of residual liquid that remains after the next dispense is 0.6 mls of liquid. In some embodiments, the volume of residual liquid that remains after the next dispense is 0.7 mls of liquid. In some embodiments, the volume of residual liquid that remains after the next dispense is 0.8 mls of liquid. In some embodiments, the volume of residual liquid that remains after the next dispense is 0.9 mls of liquid. In some embodiments, the volume of residual liquid that remains after the next dispense is less 1.0 mls of liquid. In some embodiments, the volume of residual liquid that remains after the next dispense is less than 2.0 mls of liquid. In some embodiments, the volume of residual liquid that remains after the next dispense is less than 3.0 mls of liquid. In some embodiments, the volume of residual liquid that remains after the next dispense is less than 4.0 mls of liquid.

In some embodiments, the volume of residual liquid that remains after the next dispense is up to 100% of the total uncompressed volume of the air pump chamber. In some embodiments, the volume of residual liquid that remains after the next dispense is up to 90% of the total uncompressed volume of the air pump chamber. In some embodiments, the volume of residual liquid that remains after the next dispense is up to 80% of the total uncompressed volume of the air pump chamber. In some embodiments, the volume of residual liquid that remains after the next dispense is up to 70% of the total uncompressed volume of the air pump chamber. In some embodiments, the volume of residual liquid that remains after the next dispense is up to 60% of the total uncompressed volume of the air pump chamber. In some embodiments, the volume of residual liquid that remains after the next dispense is up to 50% of the total uncompressed volume of the air pump chamber. In some embodiments, the volume of residual liquid that remains after the next dispense is up to 40% of the total uncompressed volume of the air pump chamber. In some embodiments, the volume of residual liquid that remains after the next dispense is up to 30% of the total uncompressed volume of the air pump chamber. In some embodiments, the volume of residual liquid that remains after the next dispense is up to 25% of the total uncompressed volume of the air pump chamber. In some embodiments, the volume of residual liquid that remains after the next dispense is up to 20% of the total uncompressed volume of the air pump chamber. In some embodiments, the volume of residual liquid that remains after the next dispense is up to 10% of the total uncompressed volume of the air pump chamber. In some embodiments, the volume of residual liquid that remains after the next dispense is up to 8% of the total uncompressed volume of the air pump chamber. In some embodiments, the volume of residual liquid that remains after the next dispense is up to 5% of the total uncompressed volume of the air pump chamber. In some embodiments, the volume of residual liquid that remains after the next dispense is up to 3% of the total uncompressed volume of the air pump chamber.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. It is not the intention of the applicant to restrict or in any way limit the scope of the appended claims to such detail. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order in which the steps are presented to be construed as required or necessary unless expressly so stated.

1. A method for dispensing foam comprising:
providing a dispenser having
a reservoir;
a foam pump located above the reservoir;
the foam pump comprising;
a foam generator;
a liquid pump chamber;
a liquid pump chamber inlet;
a liquid pump chamber outlet;
the liquid pump chamber outlet located below the liquid pump chamber inlet;
a passageway extending from the liquid pump chamber outlet to the foam generator;
an air pump chamber; and
an opening located in the air pump chamber placing the air pump chamber in fluid communication with the passageway;
wherein the opening is located proximate the top of the air pump chamber;
wherein the area above the opening is an upper air pump chamber portion of the air pump chamber and wherein the area below the opening is a lower air pump chamber portion;
causing the dispenser to be operated,
wherein operating the dispenser compresses the liquid pump chamber and the air pump chamber to dispense foam;
wherein during operation of the dispenser, residual foam made of residual liquid and air is drawn into the air pump chamber as the air pump chamber expands;
wherein the residual liquid settles at the bottom of the air pump chamber;
wherein the air pump chamber is configured so that the residual liquid builds up during operation of the dispenser and residual liquid remains in the bottom of the air pump chamber after a selected number of operations of the dispenser to dispense foam.

2. The method of producing foam of claim 1, wherein the uncompressed portion of the air pump chamber is configured to retain a volume of at least 0.3 milliliters of liquid.

3. The method of producing foam of claim 1, wherein the uncompressed portion of the air pump chamber is configured to retain a volume of at least 0.7 milliliters of liquid.

4. (canceled)

5. The method of producing foam of claim 1, wherein providing the dispenser comprises providing an air pump chamber having a volume of the upper pump chamber that is 10% or less than a volume of the lower pump chamber.

6. The method of producing foam of claim 1, wherein providing the dispenser comprises providing the opening in the air pump chamber such that the height of the opening from the bottom of the lower pump chamber to the opening is at least 4 times the height from the opening to the top of the upper air pump chamber.

7. (canceled)

8. The method of producing foam of claim 1, wherein providing the dispenser comprises providing the opening in the air pump chamber such that the width of the lower pump chamber is at least 2 times the width of the upper air pump chamber.

9. (canceled)

10. An upright foam dispenser comprising:
a reservoir;
a foam pump located above the reservoir;
the foam pump comprising;
a foam generator;
a liquid pump chamber;
a liquid pump chamber inlet;
a liquid pump chamber outlet;
the liquid pump chamber outlet located below the liquid pump chamber inlet;
a passageway extending from the liquid pump chamber outlet to the foam generator;
an air pump chamber;
an opening located in the air pump chamber placing the air pump chamber in fluid communication with the central passageway;
wherein the opening is located proximate the top of the air pump chamber;
wherein the area above the opening is an upper air pump chamber portion of the air pump chamber and wherein the area below the opening is a lower air pump chamber portion;
wherein the volume of the upper air pump chamber portion is less than about 15 percent of the volume of the lower air pump chamber portion;
a dip tube extending from the liquid pump chamber inlet to proximate the bottom of the reservoir; and
an outlet nozzle located above the pump;
wherein the pump is configured to draw air and residual liquid through the foam generator and outlet nozzle into the air pump chamber;
wherein the residual liquid settles at the bottom of the air pump chamber;
wherein the air pump chamber is configured so that residual liquid builds up during operation of the foam pump and remains in the bottom of the air pump chamber after a selected number of operations of the foam pump.

11. The upright dispenser of claim 10 wherein the volume of residual fluid builds to a steady level after a selected number of operations of the foam pump and after a subsequent operations of the foam pump, the volume of residual fluid that remains in the bottom of the air pump chamber is greater than 0.3 milliliters.

12. The upright dispenser of claim 10 wherein the volume of residual fluid builds to a steady level after a selected number of operations of the foam pump and after a subsequent operations of the foam pump,, the volume of residual fluid that remains in the bottom of the air pump chamber is greater than 0.34 milliliters.

13. The upright dispenser of claim 10 wherein the volume of residual fluid builds to a steady level after a selected number of operations of the foam pump and after a subsequent operations of the foam pump,, the volume of residual fluid that remains in the bottom of the air pump chamber is greater than 0.5 milliliters.

14. The upright dispenser of claim 10 wherein the volume of the upper air pump chamber portion is less than about 10 percent of the lower air pump chamber portion.

15. The upright dispenser of claim 10 wherein the volume of the upper air pump chamber portion is less than about 8 percent of the lower air pump chamber portion.

16. The upright dispenser of claim 10 wherein the volume of the upper air pump chamber portion is less than about 5 percent of the lower air pump chamber portion.

17. The upright dispenser of claim 10 wherein the height of the lower air pump chamber is at least 4 times the height of the upper air pump chamber.

18. The upright dispenser of claim 10 wherein the height of the lower air pump chamber is at least 5 times the height of the upper air pump chamber.

19-23. (canceled)

24. An upright foam dispenser comprising:
a reservoir;
a foam pump located above the reservoir;
the foam pump comprising;
a foam generator;
a liquid pump chamber;
a liquid pump chamber inlet;
a liquid pump chamber outlet;
a passageway extending upward from the liquid pump chamber outlet to the foam generator;
an air pump chamber;
an opening located in the air pump chamber placing the air pump chamber in fluid communication with the central passageway;
an upper air pump chamber portion located above the opening;
a lower air pump chamber portion located below the opening;
wherein the lower air pump chamber portion has a maximum diameter that is greater than a maximum diameter of the upper air pump chamber portion;
a dip tube extending from the liquid pump chamber inlet to proximate the bottom of the reservoir; and
an outlet nozzle;
wherein the pump is configured to draw air and residual liquid through the foam generator and outlet nozzle into the air pump chamber;
wherein the residual liquid settles in a bottom of the lower air pump chamber portion;
wherein the air pump chamber is configured so that during operation of the foam pump, residual liquid builds up and remains in the bottom of the lower air pump chamber portion.

25. The upright dispenser of claim 24 wherein the volume of residual fluid builds to a steady level after a selected number of dispenses and after a subsequent dispense, the volume of residual fluid that remains in the bottom of the air pump chamber is greater than 0.3 milliliters.

26. (canceled)

27. The upright dispenser of claim 24 wherein the volume of residual fluid builds to a steady level after a selected number of dispenses and after a subsequent dispense, the volume of residual fluid that remains in the bottom of the air pump chamber is greater than 0.5 milliliters.

28. The upright dispenser of claim 24 wherein the maximum diameter of the lower air pump chamber portion is at least 1.25 times the maximum diameter of the upper air pump portion.

29. The upright dispenser of claim 24 wherein the maximum diameter of the lower air pump chamber portion is at least 1.5 times the maximum diameter of the upper air pump portion.

30-44. (canceled)
